(19) United States
(12) Patent Application Publication
(10) Pub. No.: US 2025/0020282 A1
(43) Pub. Date: Jan. 16, 2025

(54) DIFFUSERS IN VAPORIZERS AND RELATED METHODS

(71) Applicant: ENTEGRIS, INC., Billerica, MA (US)

(72) Inventors: Scott L. Battle, Cedar Park, TX (US); Benjamin R. Garrett, Leander, TX (US); Bryan Hendrix, Danbury, CT (US); Michael Watson, Leander, TX (US); Sara Moghaddam, Dripping Springs, TX (US); Yusuke Tamaki, Tokyo (JP)

(21) Appl. No.: 18/767,649

(22) Filed: Jul. 9, 2024

Related U.S. Application Data
(60) Provisional application No. 63/526,418, filed on Jul. 12, 2023.

(51) Int. Cl. F17C 9/02

(52) U.S. Cl. CPC F17C 9/02; F17C 2265/012

(57) ABSTRACT

Diffuser plates in vaporizers, and related systems and methods, are provided. A vaporizer comprises a vessel having an outlet. The vessel contains or is configured to contain a vaporizable precursor that, when vaporized, produces a precursor vapor. The vessel discharges or is configured to discharge the precursor vapor through the outlet. The vaporizer includes a diffuser located within the vessel, between the vaporizable precursor and the outlet. The diffuser has a first surface, a second surface opposite the first surface, and a plurality of holes extending from the first surface of the diffuser through to the second surface of the diffuser.

### CROSS-REFERENCE TO RELATED APPLICATIONS

This application claims the benefit under 35 USC 119 of U.S. Provisional Patent Application No. 63/526,418, filed Jul. 12, 2023, the disclosure of which is hereby incorporated herein by reference in its entirety.

### FIELD

The present disclosure relates to the use of diffusers in vaporizers and related systems and methods.

### BACKGROUND

The presence of entrained solid particles in precursor vapors used for semiconductor fabrication results in defects and undesirable process variability. Providing precursor vapors with sufficiently low levels of solid particles remains an ongoing challenge.

### SUMMARY

Some embodiments relate to a vaporizer. In some embodiments, the vaporizer comprises a vessel having an inlet and an outlet. In some embodiments, the vaporizer comprises a diffuser located within the vessel. In some embodiments, the vessel contains a vaporizable precursor that, when vaporized, produces a metal halide vapor. In some embodiments, the vessel is configured to discharge the metal halide vapor through the outlet. In some embodiments, when an oxygen species and/or a metal halide impurity is present within the vessel, an impurity content of the metal halide vapor that is discharged from the vessel with a diffuser is less than an impurity content of a metal halide vapor that is discharged from a vessel without the diffuser.

Some embodiments relate to a method for vaporizing. In some embodiments, the method comprises obtaining a vaporizer. In some embodiments, the vaporizer comprises a vessel having an inlet and an outlet. In some embodiments, the vaporizer comprises a diffuser located within the vessel. In some embodiments, the vessel contains a vaporizable precursor that, when vaporized, produces a metal halide vapor. In some embodiments, the vessel is configured to discharge the metal halide vapor through the outlet. In some embodiments, the method comprises vaporizing the vaporizable precursor so as to produce a precursor vapor. In some embodiments, when an oxygen species or a metal halide impurity is present within the vessel, an impurity content of the precursor vapor that is discharged from the vessel is less than an impurity content of a precursor vapor that is discharged from a vessel without the diffuser.

### DRAWINGS

Some embodiments of the disclosure are herein described, by way of example only, with reference to the accompanying drawings. With specific reference now to the drawings in detail, it is stressed that the embodiments shown are by way of example and for purposes of illustrative discussion of embodiments of the disclosure. In this regard, the description taken with the drawings makes apparent to those skilled in the art how embodiments of the disclosure may be practiced.

FIG. 1 is a schematic diagram of a cross-sectional view of a vessel, according to some embodiments.

FIG. 2 is a schematic diagram of a cross-sectional view of a vaporizer, according to some embodiments.

FIG. 3 is a flowchart of a method for vaporizing, according to some embodiments.

FIG. 4 is a schematic drawing of a diffuser with asymmetric holes, according to some embodiments.

### DETAILED DESCRIPTION

Among those benefits and improvements that have been disclosed, other objects and advantages of this disclosure will become apparent from the following description taken in conjunction with the accompanying figures. Detailed embodiments of the present disclosure are disclosed herein; however, it is to be understood that the disclosed embodiments are merely illustrative of the disclosure that may be embodied in various forms. In addition, each of the examples given regarding the various embodiments of the disclosure which are intended to be illustrative, and not restrictive.

Any prior patents and publications referenced herein are incorporated by reference in their entireties.

Throughout the specification and claims, the following terms take the meanings explicitly associated herein, unless the context clearly dictates otherwise. The phrases “in one embodiment,” “in an embodiment,” and “in some embodiments” as used herein do not necessarily refer to the same embodiment(s), though it may. Furthermore, the phrases “in another embodiment” and “in some other embodiments” as used herein do not necessarily refer to a different embodiment, although it may. All embodiments of the disclosure are intended to be combinable without departing from the scope or spirit of the disclosure.

As used herein, the term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

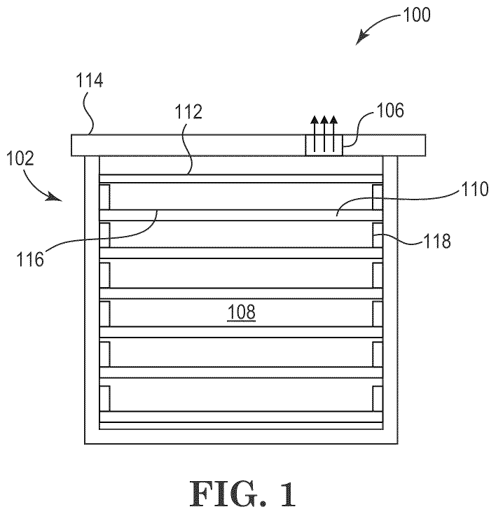

FIG. 1 is a schematic diagram of a cross-sectional view of a vaporizer 100, according to some embodiments. The vaporizer 100 may comprise a vessel 102 having an outlet 106. The vessel 102 may define an interior volume 108 of the vaporizer 100. In some embodiments, the vessel 102 is fully enclosed. In some embodiments, the vessel 102 comprises a lid 114 coupled or removably coupled to a vessel body, wherein the lid 114, when mated with the vessel body, defines the interior volume 108 of the vaporizer 100. In some embodiments, the outlet 106 is located in the lid 114. The vessel 102 may contain or may be configured to contain a vaporizable precursor, which, when vaporized, produces a precursor vapor that is dischargeable through the outlet. The vaporizable precursor may comprise solid particulate matter, such as, for example and without limitation, solid particles in the form of a powder or chunks, among other forms. In some embodiments, the vaporizer 100 comprises at least one tray 110 located within the interior volume 108 of the vessel 102. In some embodiments, the at least one tray 110 is configured to contain the vaporizable precursor. At least one of the at least one tray 110 may comprise a base 116, and a sidewall 118 extending upwards from an outer edge of the base 116. The at least one tray 110 may be configured to contact an inner surface of the vessel 102.

A diffuser 112 may be located within the vessel 102. In some embodiments, the diffuser 112 is provided in fluid communication with the precursor vapor. In some embodiments, the diffuser 112 is located within the vessel 102 such that at least a portion of the vaporizable precursor, when vaporized, contacts at least a portion of the diffuser 112. In some embodiments, the diffuser 112 is located between the vaporizable precursor and the outlet 106. In some embodiments, the diffuser 112 is located between the at least one tray 110 and the outlet 106. In some embodiments, the at least one tray 110 is one of a plurality of stacked trays located within the vessel, wherein the tray is a topmost tray of the plurality of stacked trays. In some embodiments, the at least one tray 110 may comprise a base, and a sidewall extending upwards from an outer edge of the base. In some embodiments, the diffuser 112 contacts at least a portion of a top surface of the sidewall of the at least one tray 110. In some embodiments, the diffuser 112 contacts at least a portion of a surface of the base of the at least one tray 110. In some embodiments, the diffuser 112 contacts at least a portion of a top surface of the base of the at least one tray 110. The diffuser 112 may be a plate. In some embodiments, the diffuser 112 is a substantially flat plate with holes extending between the two flat sides of the plate.

The diffuser 112 may cover at least 50% of the vaporizable precursor. In some embodiments, for example, the diffuser plate covers at least 55%, at least 60%, at least 65%, at least 70%, at least 75%, at least 80%, at least 85%, at least 90%, or at least 95% of the vaporizable precursor (e.g., the vaporizable precursor located on the topmost tray of the vaporizer). In some embodiments, the diffuser 112 covers 50% to 99%, 50% to 95%, 50% to 90%, 50% to 85%, 50% to 80%, 50% to 75%, 50% to 70%, 50% to 65%, 50% to 60%, 50% to 55%, 55% to 99%, 60% to 99%, 65% to 99%, 70% to 99%, 75% to 99%, 80% to 99%, 85% to 99%, 90% to 99%, 95% to 99% of the vaporizable precursor (e.g., the vaporizable precursor on the topmost tray of the vaporizer). In some embodiments, the diffuser 112 covers the vaporizable precursor in its entirety.

The presence of the diffuser 112 within the interior volume 108 of the vaporizer 100 unexpectedly reduces solid particulate levels in the precursor vapor. That is, in some embodiments, the diffuser 112 is configured to reduce entrainment of the vaporizable precursor in the precursor vapor (e.g., relative to a vaporizer without the diffuser). In some embodiments, the diffuser 112 is configured to reduce a velocity of the precursor vapor above the un-vaporized vaporizable precursor (e.g., relative to a vaporizer without the diffuser). In some embodiments, for example, the velocity of the precursor vapor above the un-vaporized vaporizable precursor is less than a maximum velocity of the precursor vapor flowing through the vaporizer. In some embodiments, the diffuser 112 is configured to disperse or diffuse the precursor vapor flowing above the un-vaporized vaporizable precursor. In some embodiments, the diffuser 112 has a low velocity zone after the diffuser 112 where particles may deposit onto a surface rather than being carried into the deposition zone of a deposition system.

In some embodiments, the diffuser 112 is configured to reduce a solids content of the precursor vapor existing through an outlet of the vessel relative to a precursor vapor exiting through an outlet of a vaporizer without the diffuser plate. In some embodiments, the solids content of the precursor vapor discharged from the vessel 102 may be reduced by 1%, 5%, 10%, 15%, 20%, 25%, 30%, 35%, 40%, 45%, 50%, 60%, 80%, or greater, relative to a precursor vapor exiting through an outlet of a vaporizer without the diffuser.

The diffuser 112 may be provided in any suitable form. In some embodiments, for example, the diffuser 112 has a form of at least one of a powder, a chunk, a bead, or any combination thereof. In some embodiments, the diffuser 112 has a form of at least one of a sheet, a foil, or any combination thereof. In some embodiments, the diffuser 112 comprises a plate. In some embodiments, the diffuser 112 comprises a sheet. In some embodiments, the diffuser 112 comprises a foil. In some embodiments, the diffuser 112 comprises a fibrous material. In some embodiments, the diffuser 112 comprises a frit material. In some embodiments, the diffuser 112 comprises a sintered disk. In some embodiments, the diffuser 112 comprises a metal component. In some embodiments, the diffuser 112 does not comprise stainless steel. In some embodiments, the diffuser 112 does not comprise a sidewall. In some embodiments, a dimension (e.g., a width, a length, a diameter, a radius, etc.) the diffuser 112 is less than a dimension (e.g., a width, a length, a diameter, a radius, etc.) of the vessel 102. It will be appreciated that the diffuser 112 can have other shapes, dimensions, and forms without departing from the scope of the present disclosure.

A thickness of the diffuser 112 may be in a range of 5 microns to 1000 microns, or any range or subrange between 5 microns and 1000 microns. For example, in some embodiments, a thickness of the diffuser 112 is in a range of 5 microns to 1000 microns, 5 microns to 950 microns, 5 microns to 900 microns, 5 microns to 850 microns, 5 microns to 800 microns, 5 microns to 750 microns, 5 microns to 700 microns, 5 microns to 650 microns, 5 microns to 600 microns, 5 microns to 550 microns, 5 microns to 500 microns, 5 microns to 450 microns, 5 microns to 400 microns, 5 microns to 350 microns, 5 microns to 300 microns, 5 microns to 250 microns, 5 microns to 200 microns, 5 microns to 150 microns, 5 microns to 100 microns, 5 microns to 50 microns, 5 microns to 40 microns, 5 microns to 30 microns, 5 microns to 20 microns, 5 microns to 10 microns, 50 microns to 1000 microns, 100 microns to 1000 microns, 150 microns to 1000 microns, 200 microns to 1000 microns, 250 microns to 1000 microns, 300 microns to 1000 microns, 350 microns to 1000 microns, 400 microns to 1000 microns, 450 microns to 1000 microns, 500 microns to 1000 microns, 550 microns to 1000 microns, 600 microns to 1000 microns, 650 microns to 1000 microns, 700 microns to 1000 microns, 750 microns to 1000 microns, 800 microns to 1000 microns, 850 microns to 1000 microns, 900 microns to 1000 microns, or 950 microns to 1000 microns.

An average particle size of the diffuser 112 may be in a range of 5 microns to 500 microns, or any range or subrange between 5 microns and 500 microns. In some embodiments, an average particle size of the diffuser 112 is in a range of 5 microns to 450 microns, 5 microns to 400 microns, 5 microns to 350 microns, 5 microns to 300 microns, 5 microns to 250 microns, 5 microns to 200 microns, 5 microns to 150 microns, 5 microns to 100 microns, 5 microns to 50 microns, microns to 500 microns, 50 microns to 500 microns, 100 microns to 500 microns, microns to 500 microns, 150 microns to 500 microns, 200 microns to 500 microns, microns to 500 microns, 250 microns to 500 microns, 300 microns to 500 microns, microns to 500 microns, 350 microns to 500 microns, 400 microns to 500 microns, or 450 microns to 500 microns.

In some embodiments, the diffuser 112 has a first surface and a second surface opposite the first surface. In some embodiments, the diffuser 112 defines a plurality of holes extending from the first surface of the diffuser 112 through to the second surface of the diffuser 112. In some embodiments, the plurality of holes comprises circular-shaped holes. In some embodiments, the plurality of holes comprises slot-shaped holes. In some embodiments, the plurality of holes is arranged in a symmetric pattern. In some embodiments, the plurality of holes is arranged in an asymmetric pattern. In some embodiments, the diffuser 112 is oriented within the vaporizer 100 such that the plurality of holes offsets or at least partially offsets holes formed in the at least one tray. As used herein, the term “offsets” refers to not overlapping. For example, in some embodiments, if the plurality of holes of the diffuser 112 are arranged in the same pattern as holes in the at least one tray, and the plurality of holes are located directly over the holes in the at least one tray, the diffuser 112 and the at least one tray are not considered to be offset. In some embodiments, if at least one of the holes of the diffuser 112 is not located directly over at least one hole in the at least one tray, the diffuser 112 and the at least one tray is considered at least partially offset. In some embodiments, if none of the holes of the diffuser 112 is located directly over the holes in the at least one tray, the diffuser 112 and the at least one tray is considered be offset.

The vaporizable precursor may be a solid vaporizable precursor, or the vaporizable precursor can be present in another phase, such as, for example and without limitation, at least one of a solid, a liquid, a gas, a vapor, or any combination thereof. The vaporizable precursor may comprise a metal halide. The metal halide may comprise at least one of an aluminum halide, a hafnium halide, a zirconium halide, a titanium halide, a silicon halide, a phosphorus halide, or any combination thereof. In some embodiments, the aluminum halide comprises at least one of an aluminum chloride (e.g., AlCl, AlCl₃, hydrates thereof, and the like), an aluminum bromide (e.g., AlBr, AlBr₃, Al₂Br₆, hydrates thereof, and the like), an aluminum fluoride (e.g., AlF, AlF₃, hydrates thereof, and the like), an aluminum iodide (e.g., AlI, AlI₃, hydrates thereof, and the like), or any combination thereof. In some embodiments, the hafnium halide comprises at least one of hafnium (IV) chloride (HfCl₄), hafnium (IV) bromide (HfBr₄), hafnium (IV) iodide (HfI₄), hafnium (IV) fluoride (HfF₄), hafnium (III) chloride (HfCl₃), hafnium (III) bromide (HfBr₃), hafnium (III) iodide (HfI₃), hafnium (III) fluoride (HfF₃), or any combination thereof. In some embodiments, the zirconium halide comprises at least one of ZrCl₃, ZrCl₄, hydrates thereof, or any combination thereof. In some embodiments, the titanium halide comprises at least one of TiCl₄, TiBr₄, TiF₄, TiI₄, TiCl₃, TiBr₃, TiF₃, TiCl₂, TiBr₂, TiI₂, hydrates thereof, or any combination thereof. In some embodiments, the silicon halide comprises at least one of SiCl₄, SiBr₄, SiF₄, SiI₄, hydrates thereof, or any combination thereof. In some embodiments, the phosphorus halide comprises at least one of PF₅, PCl₅, PBr₅, PBr₇, PI₅, hydrates thereof, or any combination thereof.

The precursor vapor may comprise a metal halide vapor. The metal halide vapor may comprise at least one of an aluminum halide, a hafnium halide, a zirconium halide, a titanium halide, a silicon halide, a phosphorus halide, or any combination thereof. In some embodiments, the aluminum halide comprises at least one of an aluminum chloride (e.g., AlCl, AlCl₃, hydrates thereof, and the like), an aluminum bromide (e.g., AlBr, AlBr₃, Al₂Br₆, hydrates thereof, and the like), an aluminum fluoride (e.g., AlF, AlF₃, hydrates thereof, and the like), an aluminum iodide (e.g., AlI, AlI₃, hydrates thereof, and the like), or any combination thereof. In some embodiments, the hafnium halide comprises at least one of hafnium (IV) chloride (HfCl₄), hafnium (IV) bromide (HfBr₄), hafnium (IV) iodide (HfI₄), hafnium (IV) fluoride (HfF₄), hafnium (III) chloride (HfCl₃), hafnium (III) bromide (HfBr₃), hafnium (III) iodide (HfI₃), hafnium (III) fluoride (HfF₃), or any combination thereof. In some embodiments, the zirconium halide comprises at least one of ZrCl₃, ZrCl₄, hydrates thereof, or any combination thereof. In some embodiments, the titanium halide comprises at least one of TiCl₄, TiBr₄, TiF₄, TiI₄, TiCl₃, TiBr₃, TiF₃, TiCl₂, TiBr₂, TiI₂, hydrates thereof, or any combination thereof. In some embodiments, the silicon halide comprises at least one of SiCl₄, SiBr₄, SiF₄, SiI₄, hydrates thereof, or any combination thereof. In some embodiments, the phosphorus halide comprises at least one of PF₅, PCl₅, PBr₅, PBr₇, PI₅, hydrates thereof, or any combination thereof.

The diffuser 112 may comprise at least one of an aluminum material, an aluminum alloy material, a hafnium material, a zirconium material, a titanium material, a silicon material, a phosphorus material, or any combination thereof. In some embodiments, the diffuser 112 may comprise at least one of a substantially pure aluminum material, an aluminum alloy material, a substantially pure hafnium material, a substantially pure zirconium material, a substantially pure titanium material, a substantially pure silicon material, a substantially pure phosphorus material, or any combination thereof. In some embodiments, the diffuser 112 further comprises an inert material. In some embodiments, the inert material comprises carbon, silica, or a combination thereof. In some embodiments, the diffuser plate is substantially free of at least one of Mg, Ti, Si, Zr, Hf, Cr, Zr, V, or any combination thereof.

In some embodiments, the aluminum material comprises at least one of an aluminum powder, an aluminum chunk(s), an aluminum bead(s), an aluminum sheet, an aluminum foil, an aluminum plate, an aluminum fiber(s), a sintered aluminum disk, or any combination thereof. In some embodiments, the substantially pure aluminum material comprises at least one of a substantially pure Al powder, a substantially pure aluminum chunk(s), a substantially pure aluminum bead(s), a substantially pure aluminum sheet, a substantially pure aluminum foil, a substantially pure aluminum plate, a substantially pure aluminum fibers, a substantially pure sintered aluminum disk, or any combination thereof. In some embodiments, the aluminum alloy material comprises at least one of a 443 series aluminum alloy, a 444 series aluminum alloy, a 1050 series aluminum alloy, a 2011 series aluminum alloy, or any combination thereof. In some embodiments, the aluminum alloy material comprises at least one of Fe, Ni, Cu, or any combination thereof. In some embodiments, the aluminum alloy material is substantially free of an impurity-forming metal. In some embodiments, the impurity-forming metal comprises at least one of Mg, Ti, Si, Zr, Hf, Cr, Zr, or any combination thereof. In some embodiments, the diffuser 112 is formed of the substantially pure aluminum material. In some embodiments, the diffuser 112 is formed of the substantially pure aluminum alloy material.

In some embodiments, the hafnium material comprises at least one of a hafnium powder, a hafnium chunk(s), a hafnium bead(s), a hafnium sheet, a hafnium foil, a hafnium plate, a hafnium fibers, a sintered hafnium disk, or any combination thereof. In some embodiments, the substantially pure hafnium material comprises at least one of a substantially pure hafnium powder, a substantially pure hafnium chunk(s), a substantially pure hafnium bead(s), a substantially pure hafnium sheet, a substantially pure hafnium foil, a substantially pure hafnium plate, a substantially pure hafnium fibers, a substantially pure sintered hafnium disk, or any combination thereof. In some embodiments, the diffuser 112 is formed of the substantially pure hafnium material.

In some embodiments, the zirconium material comprises at least one of a zirconium powder, a zirconium chunk(s), a zirconium bead(s), a zirconium sheet, a zirconium foil, a zirconium plate, a zirconium fibers, a sintered zirconium disk, or any combination thereof. In some embodiments, the substantially pure zirconium material comprises at least one of a substantially pure zirconium powder, a substantially pure zirconium chunk(s), a substantially pure zirconium bead(s), a substantially pure zirconium sheet, a substantially pure zirconium foil, a substantially pure zirconium plate, a substantially pure zirconium fibers, a substantially pure sintered zirconium disk, or any combination thereof. In some embodiments, the diffuser 112 is formed of the substantially pure zirconium material.

In some embodiments, the titanium material comprises at least one of a titanium powder, a titanium chunk(s), a titanium bead(s), a titanium sheet, a titanium foil, a titanium plate, a titanium fibers, a sintered titanium disk, or any combination thereof. In some embodiments, the substantially pure titanium material comprises at least one of a substantially pure titanium powder, a substantially pure titanium chunk(s), a substantially pure titanium bead(s), a substantially pure titanium sheet, a substantially pure titanium foil, a substantially pure titanium plate, a substantially pure titanium fibers, a substantially pure sintered titanium disk, or any combination thereof. In some embodiments, the diffuser 112 is formed of the substantially pure titanium material. In some embodiments, the diffuser 112 does not comprise aluminum, vanadium, or aluminum and vanadium. In some embodiments, the diffuser 112 is substantially free of aluminum. In some embodiments, the diffuser 112 is substantially free of vanadium. In some embodiments, the diffuser 112 is substantially free of aluminum and vanadium.

In some embodiments, the silicon material comprises at least one of a silicon powder, a silicon chunk(s), a silicon bead(s), a silicon sheet, a silicon foil, a silicon plate, a silicon fibers, a sintered silicon disk, or any combination thereof. In some embodiments, the substantially pure silicon material comprises at least one of a substantially pure silicon powder, a substantially pure silicon chunk(s), a substantially pure silicon bead(s), a substantially pure silicon sheet, a substantially pure silicon foil, a substantially pure silicon plate, a substantially pure silicon fibers, a substantially pure sintered silicon disk, or any combination thereof. In some embodiments, the diffuser 112 is formed of the substantially pure silicon material.

In some embodiments, the phosphorus material comprises at least one of a phosphorus powder, a phosphorus chunk(s), a phosphorus bead(s), a phosphorus sheet, a phosphorus foil, a phosphorus plate, a phosphorus fibers, a sintered phosphorus disk, or any combination thereof. In some embodiments, the substantially pure phosphorus material comprises at least one of a substantially pure phosphorus powder, a substantially pure phosphorus chunk(s), a substantially pure phosphorus bead(s), a substantially pure phosphorus sheet, a substantially pure phosphorus foil, a substantially pure phosphorus plate, a substantially pure phosphorus fibers, a substantially pure sintered phosphorus disk, or any combination thereof. In some embodiments, the diffuser 112 is formed of the substantially pure phosphorus material.

In some embodiments, the vaporizable precursor comprises an aluminum halide and the diffuser 112 comprises a substantially pure aluminum material. In some embodiments, the vaporizable precursor comprises at least one of AlCl, AlCl₃, AlBr, AlBr₃, Al₂Br₆, AlF, AlF₃, AlI, AlI₃, or any combination thereof, and the diffuser plate comprises a substantially pure aluminum material. In some embodiments, the vaporizable precursor comprises an aluminum halide and the diffuser plate comprises an aluminum alloy material. In some embodiments, the vaporizable precursor comprises AlCl₃ and the diffuser 112 comprises an aluminum alloy material. In some embodiments, the metal halide vapor comprises an aluminum halide and the diffuser 112 comprises a substantially pure aluminum material. In some embodiments, the metal halide vapor comprises at least one of AlCl, AlCl₃, AlBr, AlBr₃, Al₂Br₆, AlF, AlF₃, AlI, AlI₃, or any combination thereof, and the diffuser 112 comprises a substantially pure aluminum material. In some embodiments, the metal halide vapor comprises an aluminum halide and the diffuser 112 comprises an aluminum alloy material. In some embodiments, the metal halide vapor comprises AlCl₃ and the diffuser 112 comprises an aluminum alloy material.

In some embodiments, the vaporizable precursor comprises a hafnium halide and the diffuser plate comprises a substantially pure hafnium material. In some embodiments, the vaporizable precursor comprises at least one of HfCl₄, HfBr₄, HfI₄, HfF₄, HfCl₃, HfBr₃, HfI₃, HfF₃, or any combination thereof, and the diffuser plate comprises a substantially pure hafnium material. In some embodiments, the metal halide vapor comprises a hafnium halide and the diffuser 112 comprises a substantially pure hafnium material. In some embodiments, the metal halide vapor comprises at least one of HfCl₄, HfBr₄, HfI₄, HfF₄, HfCl₃, HfBr₃, HfI₃, HfF₃, or any combination thereof, and the diffuser 112 comprises a substantially pure hafnium material.

In some embodiments, the vaporizable precursor comprises a zirconium halide and the diffuser 112 comprises a substantially pure zirconium material. In some embodiments, the vaporizable precursor comprises ZrCl₃, ZrCl₄, or any combination thereof, and the diffuser 112 comprises a substantially pure zirconium material. In some embodiments, the metal halide vapor comprises a zirconium halide and the diffuser 112 comprises a substantially pure zirconium material. In some embodiments, the metal halide vapor comprises ZrCl₃, ZrCl₄, or any combination thereof, and the diffuser 112 comprises a substantially pure zirconium material.

In some embodiments, the vaporizable precursor comprises a titanium halide and the diffuser 112 comprises a substantially pure titanium material. In some embodiments, the vaporizable precursor comprises at least one of TiCl₄, TiBr₄, TiF₄, TiI₄, TiCl₃, TiBr₃, TiF₃, TiCl₂, TiBr₂, TiI₂, or any combination thereof, and the diffuser 112 comprises a substantially pure titanium material. In some embodiments, the metal halide vapor comprises a titanium halide and the diffuser 112 comprises a substantially pure titanium material. In some embodiments, the metal halide vapor comprises at least one of TiCl₄, TiBr₄, TiF₄, TiI₄, TiCl₃, TiBr₃, TiF₃, TiCl₂, TiBr₂, TiI₂, or any combination thereof, and the diffuser 112 comprises a substantially pure titanium material.

In some embodiments, the vaporizable precursor comprises a silicon halide and the diffuser 112 comprises a substantially pure silicon material. In some embodiments, the vaporizable precursor comprises at least one of SiCl₄, SiBr₄, SiF₄, SiI₄, or any combination thereof, and the diffuser 112 comprises a substantially pure silicon material. In some embodiments, the metal halide vapor comprises a silicon halide and the diffuser 112 comprises a substantially pure silicon material. In some embodiments, the metal halide vapor comprises at least one of SiCl₄, SiBr₄, SiF₄, SiI₄, or any combination thereof, and the diffuser plate comprises a substantially pure silicon material.

In some embodiments, the vaporizable precursor comprises a phosphorus halide and the diffuser 112 comprises a substantially pure phosphorus material. In some embodiments, the vaporizable precursor comprises at least one of PF₅, PCl₅, PBr₅, PBr₇, PI₅, or any combination thereof, and the diffuser 112 comprises a substantially pure phosphorus material. In some embodiments, the metal halide vapor comprises a phosphorus halide and the diffuser 112 comprises a substantially pure phosphorus material. In some embodiments, the metal halide vapor comprises at least one of PF₅, PCl₅, PBr₅, PBr₇, PI₅, or any combination thereof, and the diffuser 112 comprises a substantially pure phosphorus material.

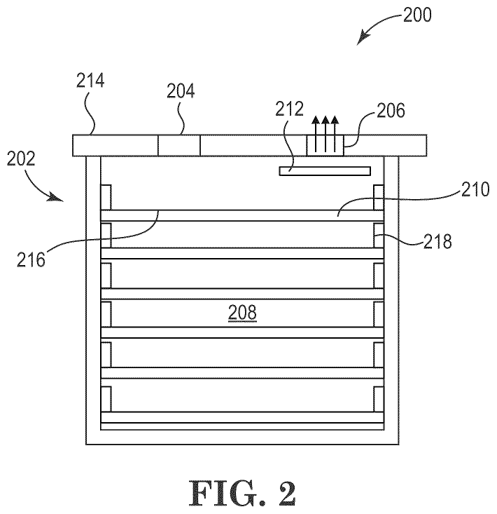

FIG. 2 is a schematic diagram of a cross-sectional view of a vaporizer 200, according to some embodiments. The vaporizer 200 may comprise a vessel 202 having an inlet 204 and an outlet 206. The vessel 202 may define an interior volume 208 of the vaporizer 200. In some embodiments, the vessel 202 is fully enclosed. In some embodiments, the vessel 202 comprises a lid 214 coupled or removably coupled to a vessel body, wherein the lid 214, when mated with the vessel body, defines the interior volume 208 of the vaporizer 200. In some embodiments, at least one of the inlet 204, the outlet 206, or any combination thereof, is located in the lid 214. The vessel 202 may contain or may be configured to contain a vaporizable precursor, which, when vaporized, produces a precursor vapor, such as, for example and without limitation, a metal halide vapor, that is dischargeable through the outlet. In some embodiments, the vaporizer 200 comprises at least one tray 210 located within the interior volume 208 of the vessel 202. In some embodiments, the at least one tray 210 is configured to contain the vaporizable precursor. At least one of the at least one tray 210 may comprise a base 216, and a sidewall 218 extending upwards from an outer edge of the base 216. The at least one tray 210 may be configured to contact an inner surface of the vessel 202. In some embodiments, the diffuser 212 is located between a topmost tray of the at least one tray 210 and the outlet 206.

In some embodiments, a carrier gas is provided at the inlet 204. The carrier gas may induce vaporization of the vaporizable precursor in the interior volume 208 of the vessel 202. The carrier gas moves through the interior volume 208 of the vessel 202 and accumulates vaporized precursor before passing through the diffuser 212 and going through the outlet 206. After passing through the diffuser 212, the velocity of the carrier gas may drop, allowing particulate to settle out of the gas stream. This may reduce the amount of particulate provided by the vessel 202 to a deposition zone of a deposition system. This reduction in particulate due to the diffuser 212 provides benefits over previous designs which lacked a diffuser 212 to reduce particulate in the gas stream.

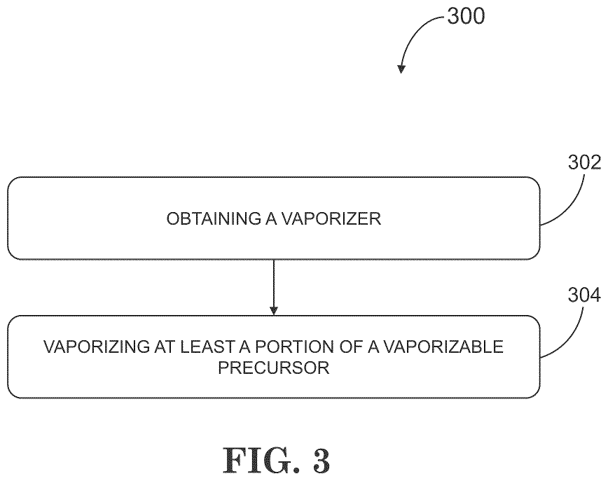

FIG. 3 is a flowchart of a method for vaporizing, according to some embodiments. As shown in FIG. 3, in some embodiments, the method comprises obtaining 302 a vaporizer. In some embodiments, the vaporizer comprises a vessel having an outlet. In some embodiments, the vaporizer comprises a diffuser located within the vessel. In some embodiments, the vessel contains a vaporizable precursor that, when vaporized, produces a metal halide vapor. In some embodiments, the vessel is configured to discharge the metal halide vapor through the outlet. In some embodiments, the method comprises vaporizing 304 at least a portion of the vaporizable precursor so as to produce a precursor vapor. In some embodiments, when an oxygen species or a metal halide impurity is present within the vessel, an impurity content of the precursor vapor that is discharged from the vessel is less than an impurity content of a precursor vapor that is discharged from a vessel without the diffuser. The method may include passing the vaporized precursor through the diffuser prior to providing the vaporized precursor to the outlet.

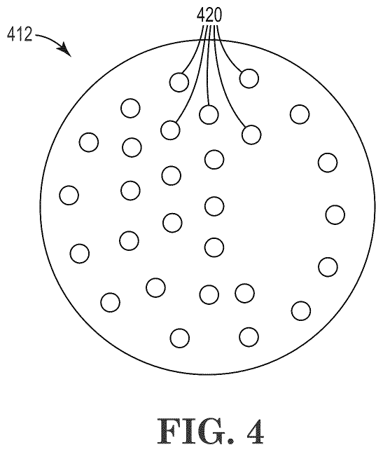

FIG. 4 is a schematic drawing of a diffuser 412 with asymmetric holes 420, according to some embodiments. As can be seen in FIG. 4, the holes 420 are arranged asymmetrically on the diffuser 412. This approach provides benefits in locating the low velocity gas stream after passing through the holes 420 away from an outlet (FIG. 2, 206) of the vessel (FIG. 2, 202). In some embodiments, the diffuser 412 with asymmetric holes 420 includes a first region with a first density of holes 420 and a second region with a second, lower density of holes 420. In one embodiment, the second region has no holes 420 and is located near the outlet of the vessel.

### Aspects

Various Aspects are described below. It is to be understood that any one or more of the features recited in the following Aspect(s) can be combined with any one or more other Aspect(s).

Aspect 1. A vaporizer comprising:
a vessel having an outlet,
   wherein the vessel contains a vaporizable precursor that, when vaporized, produces a precursor vapor;
a diffuser located within the vessel, between the vaporizable precursor and the outlet;
   wherein the diffuser has a first surface, a second surface opposite the first surface, and a plurality of holes extending from the first surface of the diffuser through to the second surface of the diffuser.

Aspect 2. The vaporizer according to Aspect 1, wherein the vessel comprises:
a vessel body; and
a lid removably coupled to the vessel body,
   wherein the lid, when mated with the vessel body, defines an interior volume of the vessel body;
   wherein an inlet and the outlet of the vessel are located in the lid.

Aspect 3. The vaporizer according to any one of Aspects 1-2, further comprising:
a tray located within the vessel,
   wherein the tray is configured to support the vaporizable precursor;
   wherein the diffuser is located within the vessel between the tray and the outlet.

Aspect 4. The vaporizer according to Aspect 3, wherein the tray is one of a plurality of stacked trays located within the vessel, wherein the tray is a topmost tray of the plurality of stacked trays.

Aspect 5. The vaporizer according to Aspect 3, wherein:
the tray comprises:
   a base; and
   a sidewall extending upwards from an outer edge of the base; and
the diffuser is located on at least a portion of the tray.

Aspect 6. The vaporizer according to Aspect 5, wherein the diffuser contacts at least a portion of a top surface of the sidewall of the tray.

Aspect 7. The vaporizer according to Aspect 6, wherein the diffuser contacts at least a portion of a top surface of the base of the tray.

Aspect 8. The vaporizer according to any one of Aspects 1-7, wherein a width of the diffuser is less than a width of the vessel.

Aspect 9. The vaporizer according to any one of Aspects 1-8, wherein the diffuser is a plate.

Aspect 10. The vaporizer according to any one of Aspects 1-9, wherein the diffuser comprises a sheet.

Aspect 11. The vaporizer according to any one of Aspects 1-10, wherein the diffuser comprises a frit material.

Aspect 12. The vaporizer according to any one of Aspects 1-11, wherein the diffuser comprises a foil.

Aspect 13. The vaporizer according to any one of Aspects 1-12, wherein the diffuser comprises a fibrous material.

Aspect 14. The vaporizer according to any one of Aspects 1-13, wherein the diffuser comprises a sintered disk.

Aspect 15. The vaporizer according to any one of Aspects 1-14, wherein the plurality of holes comprises circular-shaped holes.

Aspect 16. The vaporizer according to any one of Aspects 1-14, wherein the plurality of holes comprises slot-shaped holes.

Aspect 17. The vaporizer according to any one of Aspects 1-16, wherein the plurality of holes is arranged in a symmetric pattern.

Aspect 18. The vaporizer according to any one of Aspects 1-16, wherein the plurality of holes is arranged in an asymmetric pattern.

Aspect 19. The vaporizer according to any one of Aspects 1-18, wherein the diffuser does not comprise stainless steel.

Aspect 20. The vaporizer according to any one of Aspects 1-19, wherein the diffuser covers at least 50% of the vaporizable precursor.

It is to be understood that changes may be made in detail, especially in matters of the construction materials employed and the shape, size, and arrangement of parts without departing from the scope of the present disclosure. This Specification and the embodiments described are examples, with the true scope and spirit of the disclosure being indicated by the claims that follow.

What is claimed is:

1. A vaporizer comprising:
a vessel having an outlet,
wherein the vessel contains a vaporizable precursor that, when vaporized, produces a precursor vapor;
a diffuser plate located within the vessel, between the vaporizable precursor and the outlet;
wherein the diffuser has a first surface, a second surface opposite the first surface, and a plurality of holes extending from the first surface of the diffuser through to the second surface of the diffuser.

2. The vaporizer of claim 1, wherein the vessel comprises:
a vessel body; and
a lid removably coupled to the vessel body,
wherein the lid, when mated with the vessel body, defines an interior volume of the vessel body;
wherein an inlet and the outlet of the vessel are located in the lid.

3. The vaporizer of claim 1, further comprising:
a tray located within the vessel,
wherein the tray is configured to support the vaporizable precursor;
wherein the diffuser is located within the vessel between the tray and the outlet.

4. The vaporizer of claim 3, wherein the tray is one of a plurality of stacked trays located within the vessel, wherein the tray is a topmost tray of the plurality of stacked trays.

5. The vaporizer of claim 3, wherein:
the tray comprises:
a base; and
a sidewall extending upwards from an outer edge of the base; and
the diffuser is located on at least a portion of the tray.

6. The vaporizer of claim 5, wherein the diffuser contacts at least a portion of a top surface of the sidewall of the tray.

7. The vaporizer of claim 6, wherein the diffuser contacts at least a portion of a top surface of the base of the tray.

8. The vaporizer of claim 1, wherein a width of the diffuser is less than a width of the vessel.

9. The vaporizer of claim 1, wherein the diffuser is a plate.

10. The vaporizer of claim 1, wherein the diffuser comprises a sheet.

11. The vaporizer of claim 1, wherein the diffuser comprises a frit material.

12. The vaporizer of claim 1, wherein the diffuser comprises a foil.

13. The vaporizer of claim 1, wherein the diffuser comprises a fibrous material.

14. The vaporizer of claim 1, wherein the diffuser comprises a sintered disk.

15. The vaporizer of claim 1, wherein the plurality of holes comprises circular-shaped holes.

16. The vaporizer of claim 1, wherein the plurality of holes comprises slot-shaped holes.

17. The vaporizer of claim 15, wherein the plurality of holes is arranged in a symmetric pattern.

18. The vaporizer of claim 15, wherein the plurality of holes is arranged in an asymmetric pattern.

19. The vaporizer of claim 1, wherein the diffuser does not comprise stainless steel.

20. The vaporizer of claim 1, wherein the diffuser covers at least 50% of the vaporizable precursor.
